(19) United States
(12) Patent Application Publication
(10) Pub. No.: US 2023/0062512 A1
(43) Pub. Date: Mar. 2, 2023

(54) CELL MOBILITY IN HANDLING MAXIMUM PERMISSIBLE EXPOSURE EVENT

(71) Applicants: Fang YUAN, San Diego, CA (US); Yan ZHOU, San Diego, CA (US); Tao LUO, San Diego, CA (US); QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 17/797,404

(22) PCT Filed: Mar. 6, 2020
(86) PCT No.: PCT/CN2020/078127

§ 371 Date: Aug. 3, 2022

(51) Int. Cl. H04W 36/00

(52) U.S. Cl. CPC H04W 36/0061; H04W 36/0085

(57) ABSTRACT

Aspects of the present disclosure relate to wireless communications, and more particularly, to techniques for handling maximum permissible exposure (MPE) events. In some cases, a UE may be configured to detect one or more MPE events and report certain measurements that may help address or avoid the detected MPE event (e.g., adding or removing a cell and/or performing a handover of the UE to another cell).

### FIELD OF THE DISCLOSURE

Aspects of the present disclosure relate to wireless communications, and more particularly, to techniques for handling maximum permissible exposure (MPE) events.

### DESCRIPTION OF RELATED ART

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

In some examples, a wireless multiple-access communication system may include a number of base stations (BSs), which are each capable of simultaneously supporting communication for multiple communication devices, otherwise known as user equipments (UEs). In an LTE or LTE-A network, a set of one or more base stations may define an eNodeB (eNB). In other examples (e.g., in a next generation, a new radio (NR), or 5G network), a wireless multiple access communication system may include a number of distributed units (DUs) (e.g., edge units (EUs), edge nodes (ENs), radio heads (RHs), smart radio heads (SRHs), transmission reception points (TRPs), etc.) in communication with a number of central units (CUs) (e.g., central nodes (CNs), access node controllers (ANCs), etc.), where a set of one or more DUs, in communication with a CU, may define an access node (e.g., which may be referred to as a BS, 5G NB, next generation NodeB (gNB or gNodeB), transmission reception point (TRP), etc.). A BS or DU may communicate with a set of UEs on downlink channels (e.g., for transmissions from a BS or DU to a UE) and uplink channels (e.g., for transmissions from a UE to BS or DU).

These multiple access technologies have been adopted in various telecommunication standards to provide a common protocol that enables different wireless devices to communicate on a municipal, national, regional, and even global level. NR (e.g., new radio or 5G) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### BRIEF SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide advantages that include improved communications between access points and stations in a wireless network.

Certain aspects provide a method for wireless communication by a user equipment. The method generally includes receiving a configuration for an uplink event to trigger measurement reporting to assist in cell mobility, detecting the event based on at least one condition specified in the configuration, and performing measurement and reporting in response to the detection.

Certain aspects provide a method for wireless communication by a network entity. The method generally includes sending a user equipment (UE) a configuration for an uplink event to trigger measurement reporting to assist in cell mobility and receiving, from the UE, a reporting of measurements taken by the UE after detecting the event based on at least one condition specified in the configuration.

Certain aspects provide means for, apparatus, and/or computer readable medium having computer executable code stored thereon, for performing the techniques described herein.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 is a block diagram conceptually illustrating an example telecommunications system, in accordance with certain aspects of the present disclosure.

FIG. 2 is a block diagram conceptually illustrating a design of an example base station (BS) and user equipment (UE), in accordance with certain aspects of the present disclosure.

FIGS. 3A-3C illustrate example MPE events.

FIGS. 4A-4B illustrate example MPE events in carrier aggregation (CA) scenarios.

FIG. 5 illustrates example operations that may be performed by a user equipment (UE), in accordance with certain aspects of the present disclosure.

FIG. 6 illustrates example operations that may be performed by a network entity, in accordance with certain aspects of the present disclosure.

FIGS. 7A-7D illustrate example event configurations, in accordance with certain aspects of the present disclosure.

FIG. 8 illustrates an example trigger configuration, in accordance with certain aspects of the present disclosure.

FIGS. 9A-9B illustrate example call flow diagrams for handling MPE events, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure relate to wireless communications, and more particularly, to techniques for handling maximum permissible exposure (MPE) events.

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

The techniques described herein may be used for various wireless communication technologies, such as LTE, CDMA, TDMA, FDMA, OFDMA, SC-FDMA and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS).

New Radio (NR) is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the wireless networks and radio technologies mentioned above as well as other wireless networks and radio technologies. For clarity, while aspects may be described herein using terminology commonly associated with 3G and/or 4G wireless technologies, aspects of the present disclosure can be applied in other generation-based communication systems, such as 5G and later, including NR technologies.

New radio (NR) access (e.g., 5G technology) may support various wireless communication services, such as enhanced mobile broadband (eMBB) targeting wide bandwidth (e.g., 80 MHz or beyond), millimeter wave (mmW) targeting high carrier frequency (e.g., 25 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe.

### Example Wireless Communications System

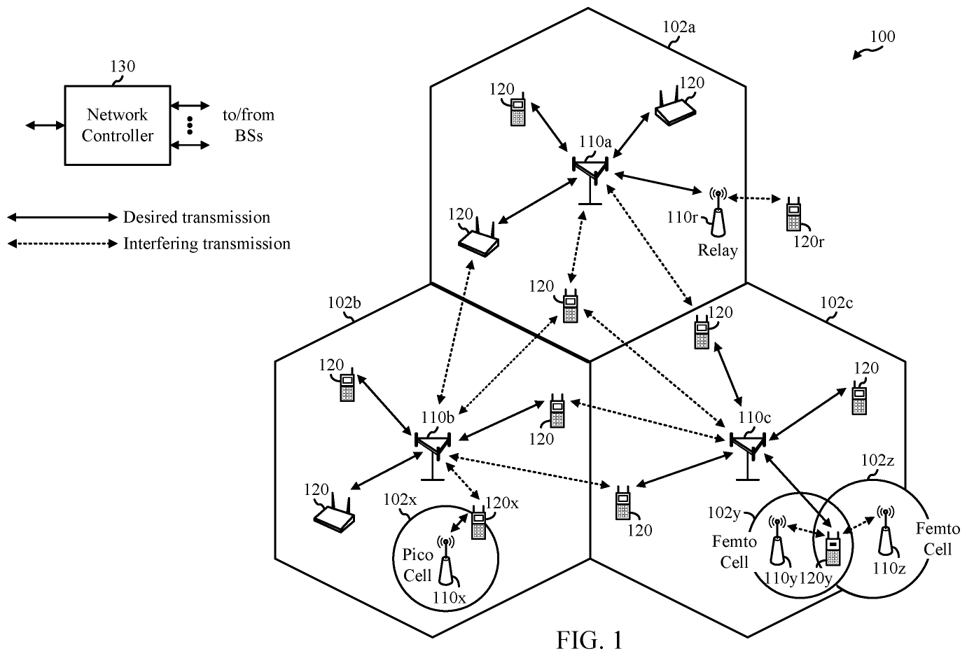

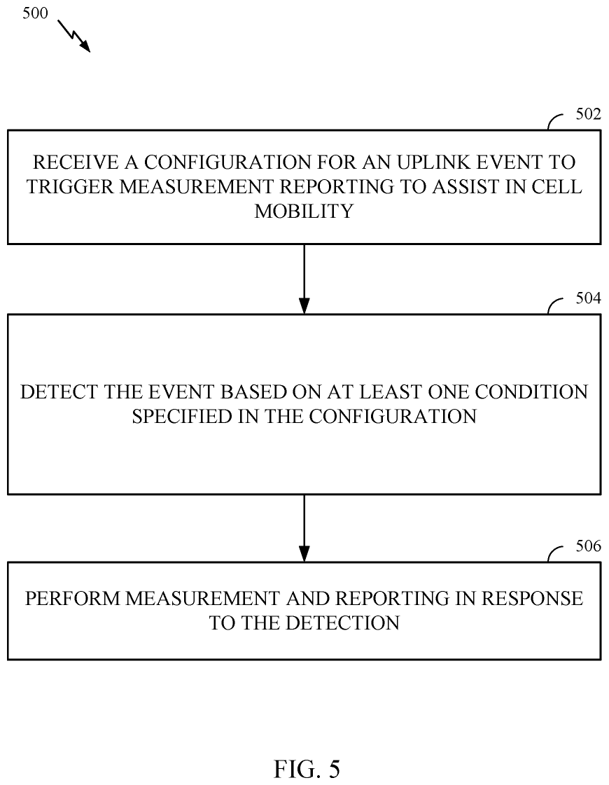

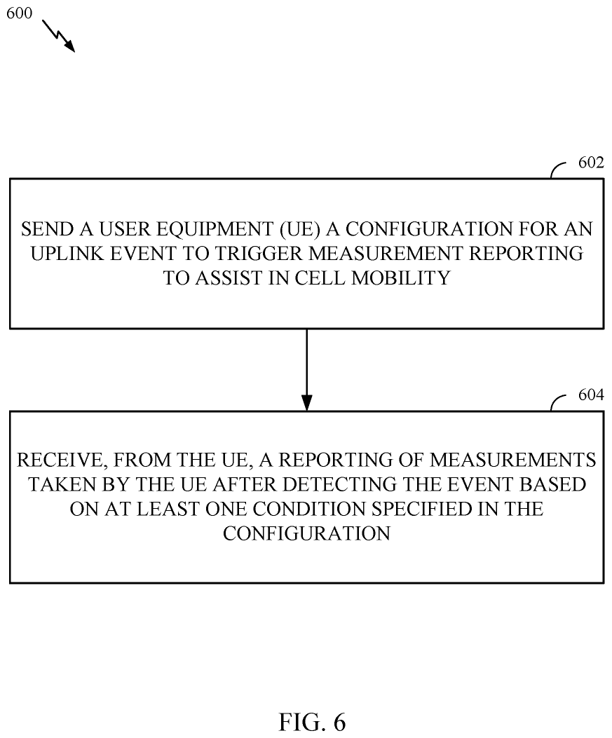

FIG. 1 illustrates an example wireless communication network 100 in which aspects of the present disclosure may be performed. For example, UEs 120 and BS 110 of FIG. 1 may be configured to perform operations described below with reference to FIGS. 5 and 6, respectively, to handle MPE events.

As illustrated in FIG. 1, the wireless communication network 100 may include a number of base stations (BSs) 110 and other network entities. A BS may be a station that communicates with user equipments (UEs). Each BS 110 may provide communication coverage for a particular geographic area. In 3GPP, the term “cell” can refer to a coverage area of a Node B (NB) and/or a NB subsystem serving this coverage area, depending on the context in which the term is used. In NR systems, the term “cell” and next generation NodeB (gNB or gNodeB), NR BS, 5G NB, access point (AP), or transmission reception point (TRP) may be interchangeable. In some examples, a cell may not necessarily be stationary, and the geographic area of the cell may move according to the location of a mobile BS. In some examples, the base stations may be interconnected to one another and/or to one or more other base stations or network nodes (not shown) in wireless communication network 100 through various types of backhaul interfaces, such as a direct physical connection, a wireless connection, a virtual network, or the like using any suitable transport network.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs. In some cases, NR or 5G RAT networks may be deployed.

A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple (e.g., three) cells.

Wireless communication network 100 may also include relay stations. A relay station is a station that receives a transmission of data and/or other information from an upstream station (e.g., a BS or a UE) and sends a transmission of the data and/or other information to a downstream station (e.g., a UE or a BS). A relay station may also be a UE that relays transmissions for other UEs. In the example shown in FIG. 1, a relay station 110r may communicate with the BS 110a and a UE 120r in order to facilitate communication between the BS 110a and the UE 120r. A relay station may also be referred to as a relay BS, a relay, etc.

Wireless communication network 100 may be a heterogeneous network that includes BSs of different types, e.g., macro BS, pico BS, femto BS, relays, etc. These different types of BSs may have different transmit power levels, different coverage areas, and different impact on interference in the wireless communication network 100. For example, macro BS may have a high transmit power level (e.g., 20 Watts) whereas pico BS, femto BS, and relays may have a lower transmit power level (e.g., 1 Watt).

Wireless communication network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time. The techniques described herein may be used for both synchronous and asynchronous operation.

A network controller 130 may couple to a set of BSs and provide coordination and control for these BSs. The network controller 130 may communicate with the BSs 110 via a backhaul. The BSs 110 may also communicate with one another (e.g., directly or indirectly) via wireless or wireline backhaul.

The UEs 120 (e.g., 120x, 120y, etc.) may be dispersed throughout the wireless communication network 100, and each UE may be stationary or mobile. A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

Certain wireless networks (e.g., LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kHz and the minimum resource allocation (called a “resource block” (RB)) may be 12 subcarriers (or 180 kHz). Consequently, the nominal Fast Fourier Transfer (FFT) size may be equal to 128, 256, 512, 1024 or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10 or 20 MHz, respectively.

While aspects of the examples described herein may be associated with LTE technologies, aspects of the present disclosure may be applicable with other wireless communications systems, such as NR. NR may utilize OFDM with a CP on the uplink and downlink and include support for half-duplex operation using TDD. Beamforming may be supported and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

In FIG. 1, a solid line with double arrows indicates desired transmissions between a UE and a serving BS, which is a BS designated to serve the UE on the downlink and/or uplink. A finely dashed line with double arrows indicates interfering transmissions between a UE and a BS.

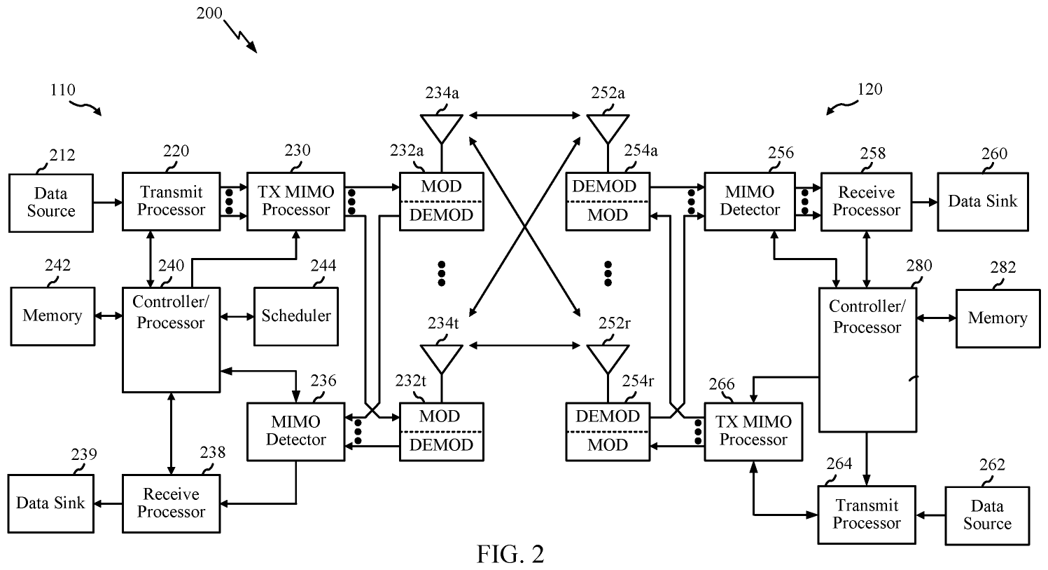

FIG. 2 shows a block diagram illustrating an example base station (BS) and an example user equipment (UE) in accordance with some aspects of the present disclosure.

At the BS 110, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. The processor 220 may process (for example, encode and symbol map) the data and control information to obtain data symbols and control symbols, respectively. The transmit processor 220 may also generate reference symbols, such as for the primary synchronization signal (PSS), secondary synchronization signal (SSS), and cell-specific reference signal (CRS). A transmit (TX) multiple-input multiple-output (MIMO) processor 230 may perform spatial processing (for example, precoding) on the data symbols, the control symbols, or the reference symbols, if applicable, and may provide output symbol streams to the modulators (MODs) 232a-232t. Each modulator 232 may process a respective output symbol stream (for example, for OFDM, etc.) to obtain an output sample stream. Each modulator may further process (for example, convert to analog, amplify, filter, and upconvert) the output sample stream to obtain a downlink signal. Downlink signals from modulators 232a-232t may be transmitted via the antennas 234a-234t, respectively.

At the UE 120, the antennas 252a-252r may receive the downlink signals from the BS 110 and may provide received signals to the demodulators (DEMODs) in transceivers 254a-254r, respectively. Each demodulator 254 may condition (for example, filter, amplify, downconvert, and digitize) a respective received signal to obtain input samples. Each demodulator may further process the input samples (for example, for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (for example, demodulate, deinterleave, and decode) the detected symbols, provide decoded data for the UE 120 to a data sink 260, and provide decoded control information to a controller/processor 280.

On the uplink, at UE 120, a transmit processor 264 may receive and process data (for example, for the physical uplink shared channel (PUSCH)) from a data source 262 and control information (for example, for the physical uplink control channel (PUCCH) from the controller/processor 280. The transmit processor 264 may also generate reference symbols for a reference signal (for example, for the sounding reference signal (SRS)). The symbols from the transmit processor 264 may be precoded by a TX MIMO processor 266 if applicable, further processed by the demodulators in transceivers 254a-254r (for example, for SC-FDM, etc.), and transmitted to the BS 110. At the BS 110, the uplink signals from the UE 120 may be received by the antennas 234, processed by the modulators 232, detected by a MIMO detector 236 if applicable, and further processed by a receive processor 238 to obtain decoded data and control information sent by the UE 120. The receive processor 238 may provide the decoded data to a data sink 239 and the decoded control information to the controller/processor 240.

The memories 242 and 282 may store data and program codes for BS 110 and UE 120, respectively. A scheduler 244 may schedule UEs for data transmission on the downlink or uplink.

The controller/processor 280 (and/or other processors and modules) at the UE 120 and/or the controller/processor 240 (and/or other processors and modules) of the BS 110 may direct perform or direct the execution of processes for the techniques described herein (e.g., with reference to FIGS. 5 and 6).

### Example Cell Mobility in Handling MPE Events

Aspects of the present disclosure relate to wireless communications, and more particularly, to techniques for handling maximum permissible exposure (MPE) events.

Upon detecting a signal path being at least partially blocked, for example, by a user hand, a UE may be configured to switch antenna panels and/or increase the transmit power to compensate for the higher path loss caused by the blockage. However, transmissions in the mmWave frequencies may have potential health impacts to human bodies. Thus, certain regulatory organizations, such as Federal Communications Commission (FCC) and International Commission on Non-Ionizing Radiation Protection (ICNIRP), impose maximum permissible exposure (MPE) constraints on transmitters at various carrier frequencies. MPE constraints are typically specified in terms of short-term temporal averaging of radiated power, medium-term temporal averaging of radiated power, local-spatial averaging of radiated power, and/or medium-spatial averaging of radiated power. Thus, while a UE may increase the transmission power at a blocked antenna or panel, the UE may be required to conform to MPE constraints imposed by regulatory organizations. As such, a UE may not be able to increase the transmission power by a sufficient amount to overcome the high path loss caused by the user's hand.

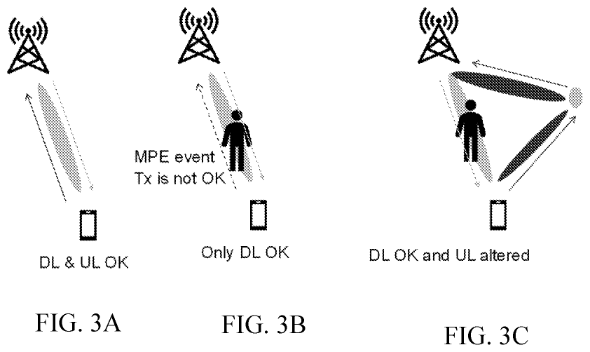

FIG. 3A illustrates an example scenario before an MPE event, where downlink and uplink transmissions are not impacted. In FIG. 3B, an MPE event occurs that impacts uplink transmissions from the UE (in the illustrated example, uplink transmissions are not possible). FIG. 3C illustrates an example scenario in which uplink transmissions may be altered (e.g., re-routed) to avoid an MPE event.

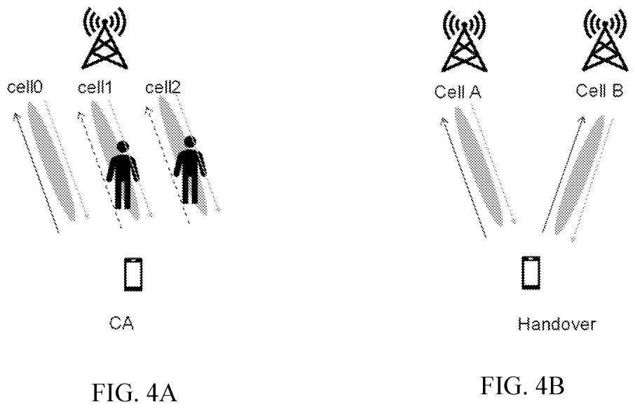

FIGS. 4A and 4B illustrates example carrier aggregation (CA) scenarios, in which MPE events may also occur. In such cases, MPE constraints need to be met for all the radios. e.g., for sub 6 GHz (3G, 4G, 5G, WiFi, and Bluetooth) and 5G NR mmWave (e.g., 28 GHz, 39 GHz, . . . ) and scenarios with simultaneous transmissions also need to meet MPE constraints. For example, in an inter-band CA scenario (e.g., 28 GHz+39 GHz or 28 GHz+60 GHz), the total MPE from the bands need to meet the MPE constraints.

Aspects of the present disclosure provide techniques that may configure a UE to be detect an MPE event and report certain measurements that may help avoid or address the MPE event (e.g., triggering a secondary cell to be added or removed or triggering a handover).

FIG. 5 illustrates example operations 500 that may be performed by a UE, in accordance with certain aspects of the present disclosure. For example, operations 500 may be performed by a UE 120 of FIG. 1 or FIG. 2.

Operations 500 begin, at 502, by receiving a configuration for an uplink event to trigger measurement reporting to assist in cell mobility. At 504, the UE detects the event based on at least one condition specified in the configuration. At 506, the UE performs measurement and reporting in response to the detection.

FIG. 6 illustrates example operations 600 that may be performed by a network entity (e.g., a gNB), in accordance with certain aspects of the present disclosure, and may be considered complementary to operations 500 of FIG. 5. For example, operations 600 may be performed by a gNB to configure a UE to detect MPE events and report measurements according to operations 500 of FIG. 5.

Operations 600 begin, at 602, by sending a user equipment (UE) a configuration for an uplink event to trigger measurement reporting to assist in cell mobility. At 604, the network entity receives, from the UE, a reporting of measurements taken by the UE after detecting the event based on at least one condition specified in the configuration.

As described above, a UE may be configured to detect various MPE events that will trigger the UE to report certain measurements.

For example, a first event may be when a potential uplink performance (e.g., based on one or more uplink performance metrics) of a neighbor cell becomes better than a threshold value. This event may be used to discover a new uplink cell for better MPE avoidance. For example, after receiving reporting of this event (or reporting triggered by this event, a gNB may respond with an SCell addition (e.g., adding the cell whose UL measurement triggered the event).

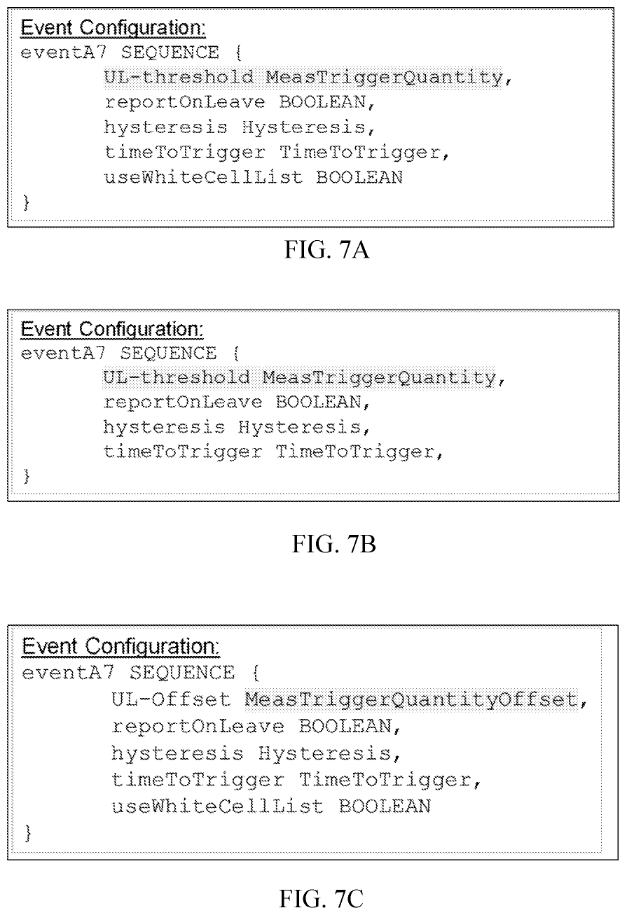

FIG. 7A illustrates an example configuration for this first event. As illustrated, the configuration may include the uplink threshold that triggers the event. In some cases, the UE may apply hysteresis (Hys) when comparing uplink measurements of a cell to the threshold value. For example, the UE may consider a condition defining this event is met if:

M_n−Hys>UL-threshold.

On the other hand, the UE may consider the condition defining this event is not met if:

M_n+Hys<UL-threshold,

where M_x represents the measurement taken on cell x.

A second event may be when the uplink performance of the serving cell becomes worse than threshold. This event may be used to trigger serving cell L3 reporting for a possible MPE event. In this case, a gNB may respond with an SCell removal.

FIG. 7B illustrates an example configuration for this second event. Again, this configuration may indicate an UL-threshold and hysteresis For example, the UE may consider a condition defining this event is met if the serving cell uplink measurement (plus hysteresis) falls below the threshold:

M_p+Hys<UL-threshold

On the other hand, the UE may consider a condition defining this event is not met if the serving cell uplink measurement (less hysteresis) exceeds the threshold:

M_n−Hys>UL-threshold.

A third event may be when a potential UL measurement of a neighbor cell (n) becomes at least an offset value better than UL measurement of the serving cell (p). This case may be used to trigger a cell change from the serving cell p to a new cell n for MPE avoidance. In this case, a gNB response to the reporting of this event may be an Scell add/remove, handover, or a conditional handover. The serving cell may be a special cell (Spcell, i.e., primary cell, or primary second cell) or a secondary cell (Scell).

As illustrated in FIG. 7C, configuration for this event may include hysteresis and offset for UL. For example, the UE may consider a condition defining this event is met if UL measurement of a neighbor cell (n) becomes at least an offset value better than UL measurement of the serving cell (p):

M_n+Of_n−Hys>M_p+Of_p+UL-Offset

On the other hand, the UE may consider the condition defining this event is not met if UL measurement of the neighbor cell (n) plus the offset value and hysteresis is less than the UL measurement and offset of the serving cell (p):

M_n+Of_n+Hys<M_p+Of_p+UL-Offset,

where Of_x represents an offset applicable to cell x.

A fourth event may be when a potential UL measurement of a serving cell (p) becomes worse than a first threshold (threshold1) and potential UL measurement of neighbor cell (n) becomes better than a second threshold (threshold2). This event may be used to trigger a cell change from cell p (a serving cell which may be an Spcell or Scell) to new cell n for MPE avoidance (e.g., a gNB response may be an Scell add/remove, handover, or conditional handover).

As illustrated in FIG. 7D, configuration for this event may specify a hysteresis and both first and second thresholds for UL in the serving and neighbor cells. For example, the UE may consider a condition defining this event is met if both the UL of the serving cell is worse than the first threshold and the potential UL of the neighbor cell is better than the second threshold:

M_p+Of_p+Hys<UL-Threshold1; and

M_n+Of_n−Hys>UL-Threshold2

On the other hand, the UE may consider the condition defining this event is not met if either the UL of the serving cell is better than the first threshold or the potential UL of the neighbor cell is worse than the second threshold:

M_p+Of_p−Hys>UL-Threshold1; or

M_n+Of_n+Hys<UL-Threshold2.

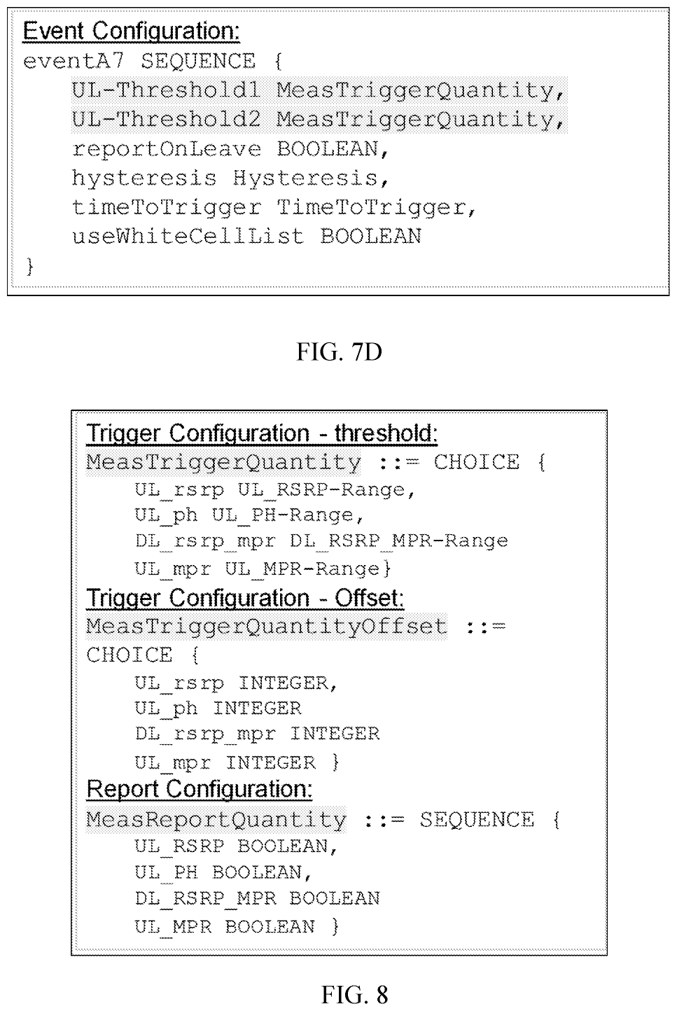

As illustrated in FIG. 8, there are various options for configuring the UE to measure for UL event reporting (via layer 3 (L3) signaling). According to a first option, a UE may measure an uplink power headroom, with an impact of power density:

UL_PH=P_{cmax_n}−pathloss_n of measurement RS(s)+PDmargin_n

where Pcmax_n is the configured maximum transmit power in cell n which may assume for maximum power reduction (MPR), power management MPR (P-MPR), and additional MPR (A-MPR):

MPR=0,

P-MPR>0 if available, otherwise 0

A-MPR>0 if available, otherwise 0

and PDmargin_n represents the power margin factor derived from the MPE regulated power density limit of frequency band of cell n. For example, PD limit may be from FCC (5 mw/cm∧2 for cell 1 on 28 GHz, 1 mw/cm∧2 for cell 2: 3 GHz). For the same MPE occasion, the difference between PDmargin_1 and PDmargin_2 may be a function of: 1) PD limit1 which is 5 mw/cm∧2 and PD limit2 which is 1 mw/cm∧2; and 2) the MPE area, which can be measured in the unit of cm∧2. According to a second option, a UE may measure UL RSRP, with impact of power density:

UL_RSRP=RSRP_n of measurement RS(s)+PDmargin_n,

where RSRP_n may be downlink layer 3 reference signal receiving power (L3-RSRP) which is derived on the measurement of a set of configured reference signals (RS) for the cell n. According to a third option, a UE may measure DL_RSRP_MPR, with impact of P-MPR:

DL_RSRP=RSRP_n of measurement RS(s)-P-MPR

for example, reducing the DL RSRP value for triggering handover in the case of UL MPE. According to a fourth option, a UE may measure the value of P_MPR in the event detection. For example, a large P_MPR value (or a smaller negative P-MPR value) for triggering handover in the case of UL MPE.

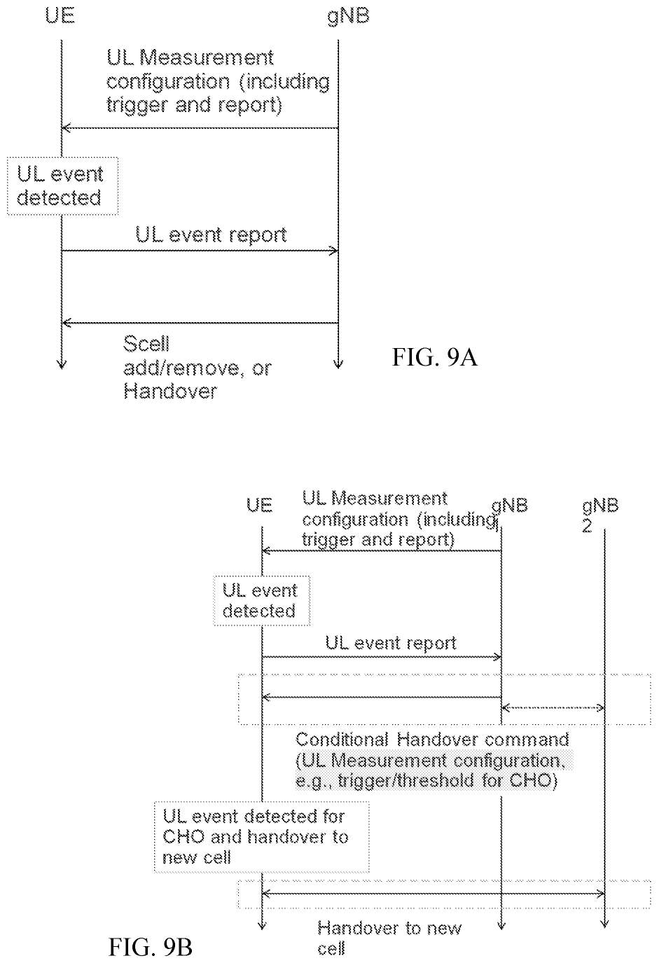

FIGS. 9A and 9B illustrate how a UE may be configured for UL measurement and reporting, according to aspects of the present disclosure. As illustrated in FIG. 9A, after configuration and detecting an UL event, the UE may report the event (and possibly corresponding measurements). In response, the gNB may add or remove and Scell or perform a handover. As illustrated in FIG. 9B, a UE may be issued a conditional handover (CHO) command that includes an UL measurement configuration (e.g., with a trigger/threshold to trigger a conditional handover to gNB2). As illustrated, upon detecting the UL event for the CHO, the UE may handover to the new cell (gNB2).

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components. For example, various operations shown in FIGS. 5 and 6 may be performed by various processors shown in FIG. 2 of the BS 110 and/or UE 120.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal 120 (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein. For example, instructions for performing the operations described herein and illustrated in FIGS. 5 and 6.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

What is claimed is:

1. A method for wireless communications by a user equipment (UE), comprising:
receiving a configuration for an uplink event to trigger measurement reporting to assist in cell mobility;
detecting the event based on at least one condition specified in the configuration; and
performing measurement and reporting in response to the detection.

2. The method of claim 1, wherein the at least one condition is designed to detect or avoid a maximum permissible exposure (MPE) event.

3. The method of claim 1, wherein:
the at least one condition is that an uplink performance metric of a neighbor cell is better than a threshold; and
the configuration specifies a value for the threshold.

4. The method of claim 3, wherein the UE considers:
the at least one condition is met if a measurement on the neighbor cell is less a hysteresis amount is greater than the value for the threshold; and
the at least one condition is not met if a measurement on the neighbor cell plus a hysteresis amount is less than the value for the threshold.

5. The method of claim 1, wherein:
the at least one condition is that an uplink performance metric of a serving cell is worse than a threshold; and
the configuration specifies a value for the threshold.

6. The method of claim 5, wherein the UE considers:
the at least one condition is met if a measurement on the serving cell plus a hysteresis amount is less than the value for the threshold; and
the at least one condition is not met if a measurement on the serving cell less a hysteresis amount is greater than the value for the threshold.

7. The method of claim 1, wherein:
the at least one condition is that an uplink performance metric of a neighbor cell is better than the uplink performance metric of a serving cell by an offset; and
the configuration specifies a value for the offset.

8. The method of claim 7, wherein the UE considers:
the at least one condition is met if a measurement on the neighbor cell plus an offset applicable to the neighbor cell less a hysteresis amount is greater than a measurement on the serving cell plus an offset applicable to the serving cell plus the value for the offset specified in the configuration; and
the at least one condition is not met if the measurement on the neighbor cell plus the offset applicable to the neighbor cell plus the hysteresis amount is less than the measurement on the serving cell plus the offset applicable to the serving cell plus the value for the offset specified in the configuration.

9. The method of claim 1, wherein the at least one condition is that:
an uplink performance metric of a serving cell is worse than a first threshold; and
an uplink performance metric of a neighbor cell is better a second threshold.

10. The method of claim 1, wherein, after the UE performs the reporting to a network entity, the network entity responds with:
a command to add a neighbor cell as a secondary cell (SCell) candidate;
a command to remove a serving cell as a secondary cell (SCell) candidate;
at least one of: a command to add the neighbor cell as a candidate secondary cell (SCell), remove the serving cell as an SCell, a handover command, or a conditional handover command; or
at least one of: a command to add the neighbor cell as a candidate secondary cell (SCell), remove the serving cell as an SCell, a handover command, or a conditional handover command.

11. The method of claim 1, wherein the UE also receives a configuration of a quantity to report.

12. The method of claim 11, wherein the UE is configured to report an uplink power headroom with impact of power density.

13. The method of claim 11, wherein the UE is configured to report an uplink reference signal receive power, with impact of power density.

14. The method of claim 11, wherein the UE is configured to report a downlink reference signal receive power minus power-management maximum power reduction.

15. The method of claim 11, wherein the UE is configured to report a power-management maximum power reduction.

16. A method for wireless communications by a network entity, comprising:
sending a user equipment (UE) a configuration for an uplink event to trigger measurement reporting to assist in cell mobility; and
receiving, from the UE, a reporting of measurements taken by the UE after detecting the event based on at least one condition specified in the configuration.

17. The method of claim 16, wherein the at least one condition is designed to detect or avoid a maximum permissible exposure (MPE) event.

18. The method of claim 16, wherein:
the at least one condition is that an uplink performance metric of a neighbor cell is better than a threshold; and
the configuration specifies a value for the threshold.

19. The method of claim 18, wherein:
the at least one condition is considered met if a measurement on the neighbor cell is less a hysteresis amount is greater than the value for the threshold; and
the at least one condition is not considered met if a measurement on the neighbor cell plus a hysteresis amount is less than the value for the threshold.

20. The method of claim 16, wherein:
the at least one condition is that an uplink performance metric of a serving cell is worse than a threshold; and
the configuration specifies a value for the threshold.

21. The method of claim 20, wherein:
the at least one condition is considered met if a measurement on the serving cell plus a hysteresis amount is less than the value for the threshold; and
the at least one condition is considered not met if a measurement on the serving cell less a hysteresis amount is greater than the value for the threshold.

22. The method of claim 16, wherein:
the at least one condition is that an uplink performance metric of a neighbor cell is better than the uplink performance metric of a serving cell by an offset; and
the configuration specifies a value for the offset.

23. The method of claim 22, wherein:
the at least one condition is considered met if a measurement on the neighbor cell plus an offset applicable to the neighbor cell less a hysteresis amount is greater than a measurement on the serving cell plus an offset applicable to the serving cell plus the value for the offset specified in the configuration; and
the at least one condition is considered not met if the measurement on the neighbor cell plus the offset applicable to the neighbor cell plus the hysteresis amount is less than the measurement on the serving cell plus the offset applicable to the serving cell plus the value for the offset specified in the configuration.

24. The method of claim 16, wherein the at least one condition is that:
an uplink performance metric of a serving cell is worse than a first threshold; and
an uplink performance metric of a neighbor cell is better a second threshold.

25. The method of claim 16, further comprising, after receiving the reporting from the UE, responding with:
a command to add a neighbor cell as a secondary cell (SCell) candidate;
a command to remove a serving cell as a secondary cell (SCell) candidate;
at least one of: a command to add the neighbor cell as a candidate secondary cell (SCell), remove the serving cell as an SCell, a handover command, or a conditional handover command; or
at least one of: a command to add the neighbor cell as a candidate secondary cell (SCell), remove the serving cell as an SCell, a handover command, or a conditional handover command.

26. The method of claim 16, further comprising configuring the UE with a quantity to report.

27. The method of claim 26, wherein the UE is configured to report an uplink power headroom with impact of power density.

28. The method of claim 26, wherein the UE is configured to report an uplink reference signal receive power, with impact of power density.

29. The method of claim 26, wherein the UE is configured to report a downlink reference signal receive power minus power-management maximum power reduction.

30. The method of claim 26, wherein the UE is configured to report a power-management maximum power reduction.

31. An apparatus for wireless communications by a user equipment (UE), comprising:
means for receiving a configuration for an uplink event to trigger measurement reporting to assist in cell mobility;
means for detecting the event based on at least one condition specified in the configuration; and
means for performing measurement and reporting in response to the detection.

32. An apparatus for wireless communications by a network entity, comprising:
means for sending a user equipment (UE) a configuration for an uplink event to trigger measurement reporting to assist in cell mobility; and
means for receiving, from the UE, a reporting of measurements taken by the UE after detecting the event based on at least one condition specified in the configuration.

33. An apparatus for wireless communications by a user equipment (UE), comprising:
a receiver configured to receive a configuration for an uplink event to trigger measurement reporting to assist in cell mobility; and
at least one processor configured to detect the event based on at least one condition specified in the configuration and performing measurement and reporting in response to the detection.

34. An apparatus for wireless communications by a network entity, comprising:
a transmitter configured to send a user equipment (UE) a configuration for an uplink event to trigger measurement reporting to assist in cell mobility; and
a receiver configured to receive, from the UE, a reporting of measurements taken by the UE after detecting the event based on at least one condition specified in the configuration.
